(19) United States
(12) Patent Application Publication
(10) Pub. No.: US 2024/0034099 A1
(43) Pub. Date: Feb. 1, 2024

(54) TIRE INSPECTION APPARATUS, TIRE INSPECTION SYSTEM, AND RECORDING MEDIUM FOR TIRE INSPECTION

(71) Applicant: TOYO TIRE CORPORATION, Itami-shi Hyogo (JP)

(72) Inventors: Yoichi Kawashima, Itami-shi Hyogo (JP); Yuki Ishijima, Itami-shi Hyogo (JP); Akinori Miyake, Itami-shi Hyogo (JP); Masato Furukawa, Itami-shi Hyogo (JP); Hiroaki Sugimoto, Itami-shi Hyogo (JP)

(21) Appl. No.: 18/358,209

(22) Filed: Jul. 25, 2023

(30) Foreign Application Priority Data
Jul. 26, 2022 (JP) 2022-119057

(51) Int. Cl. B60C 11/24; G01M 17/02; G01B 21/18

(52) U.S. Cl. CPC B60C 11/246; B60C 11/243; G01M 17/027; G01B 21/18; B60C 2200/04

(57) ABSTRACT

A tire inspection system includes a data acquisition unit, a groove depth determination unit, and an alert processing unit. The data acquisition unit acquires data for groove depth derived from measuring a groove depth of a tire mounted on a vehicle a plurality of times per groove by using the measurement instrument. The groove depth determination unit determines whether a per-groove difference in groove depth acquired by the data acquisition unit is equal to or larger than a predetermined value. When the groove depth determination unit determines that the difference is equal to or larger than the predetermined value, the alert processing unit outputs an alert to indicate that the groove depth should be measured again.

### CROSS-REFERENCE TO RELATED APPLICATION

This application is based upon and claims the benefit of priority from the prior Japanese Patent Application No. 2022-119057, filed on Jul. 26, 2022, the entire contents of which are incorporated herein by reference.

### BACKGROUND OF THE INVENTION

### 1. Field of the Invention

The present invention relates to a tire inspection apparatus, a tire inspection system, and a recording medium for tire inspection.

### 2. Description of the Related Art

Generally, a tire wears depending on the traveling condition, travel distance, etc. The wear amount varies depending on the axle position at which the tire is mounted. When the depth of a groove provided in a tire becomes equal to or less than a predetermined amount, maintenance such as exchange becomes necessary.

JP 2022-037754 A discloses a related-art tire management system. The tire management system includes a management server that manages information related to a tire mounted on each of a plurality of vehicles that have been registered, and a worker terminal carried by a worker and supports entry of information measured when a tire of the vehicle is inspected for input to the management server. The worker terminal includes: a vehicle searching unit that searches for a relevant vehicle base on the number on the number plate of the inspected vehicle captured in an image on site; a measurement information acquisition unit that acquires, from a depth gauge, information on the remaining groove depth of each tire of the inspected vehicle measured by using the depth gauge, mapping the information to the tire mounting position; and an input unit that inputs the acquired information on the remaining groove depth of the tire and the tire mounting position to information in the management server related to the tire of the searched vehicle.

### SUMMARY OF THE INVENTION

The tire management system disclosed in JP 2022-037754 A acquires and manages groove depth information measured at a plurality of locations by using a depth gauge, mapping the groove depth information to the tire mounting position. There has been a disadvantage in that, when the groove depth at a site in a tire groove that has bitten a pebble or the like is measured, the groove depth cannot be measured accurately, which requires measuring the depth for a second time after the groove depth of all tires mounted on the vehicle has been measured and lowers the work efficiency.

The present invention addresses the issue described above, and a purpose thereof is to provide a tire inspection system and a tire inspection program capable of conducting an inspection of a groove depth of a tire efficiently.

A tire inspection system according to an aspect of the present invention includes: a data acquisition unit that acquires data for groove depth derived from measuring a groove depth of a tire mounted on a vehicle a plurality of times per groove by using a groove depth measurement instrument; a groove depth determination unit that determines whether a per-groove difference in groove depth acquired by the data acquisition unit is equal to or larger than a predetermined value; and an alert processing unit that generates, when the groove depth determination unit determines that the difference is equal to or larger than the predetermined value, a notification to indicate that a groove depth should be measured again.

Another aspect of the present invention relates to a tire inspection program. The tire inspection program includes a data acquisition step that acquires data for groove depth derived from measuring a groove depth of a tire mounted on a vehicle a plurality of times per groove; a groove depth determination step that determines whether a per-groove difference in groove depth acquired by the data acquisition step is equal to or larger than a predetermined value; and an alert processing step that outputs, when the groove depth determination step determines that the difference is equal to or larger than the predetermined value, an alert to indicate that the groove depth should be measured again.

### BRIEF DESCRIPTION OF THE DRAWINGS

Embodiments will now be described, by way of example only, with reference to the accompanying drawings that are meant to be exemplary, not limiting, and wherein like elements are numbered alike in several figures, in which:

FIG. 1 is a schematic diagram showing an overall configuration of a tire inspection system according to the embodiment;

FIG. 2 is a block diagram showing a functional configuration of the tire management server apparatus;

FIG. 3 is a block diagram showing a functional configuration of the tire inspection apparatus;

FIG. 4 is a flowchart showing a sequence of steps of a process performed by the tire inspection system to measure the groove depth;

FIG. 5 is a schematic diagram showing an example of axle arrangement information;

FIG. 6 is a schematic diagram showing an exemplary image displayed on the display unit while a groove depth is being measured; and

FIG. 7 is a schematic diagram showing an exemplary image displayed on the display unit after a groove depth is measured.

### DETAILED DESCRIPTION OF THE INVENTION

The invention will now be described by reference to the preferred embodiments. This does not intend to limit the scope of the present invention, but to exemplify the invention.

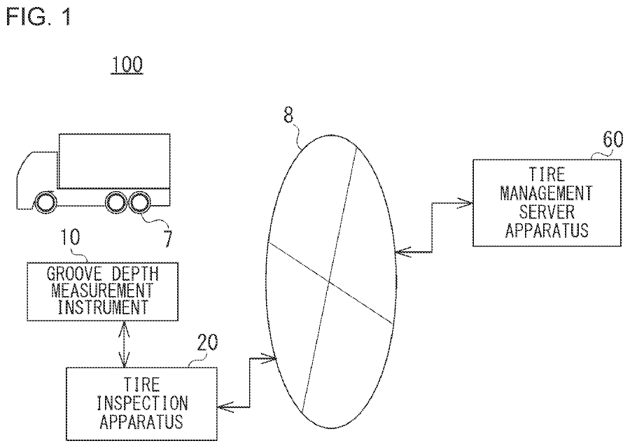

Hereinafter, the invention will be described based on a preferred embodiment with reference to FIGS. 1 through 7. Identical or like constituting elements and members shown in the drawings are represented by identical symbols and a duplicate description is omitted as appropriate. The dimension of members in the drawings is enlarged or reduced as appropriate to facilitate understanding. Those of the members that are not material to the description of the embodiment are omitted in the drawings.

### Embodiment

FIG. 1 is a schematic diagram showing an overall configuration of a tire inspection system 100 according to the embodiment. The tire inspection system 100 includes a groove depth measurement instrument 10, a tire inspection apparatus 20, and a tire management server apparatus 60. The tire inspection system 100 acquires data for groove depth obtained by inspecting each tire 7 mounted on a plurality of vehicles managed by the tire management server apparatus 60.

The tire inspection apparatus 20 acquires information on the tire 7 mounted on the vehicle and automatically determines whether the data for groove depth of each tire measured by the groove depth measurement instrument 10 a plurality of times per groove is accurate or not. The tire inspection apparatus 20 transmits the measured data for groove depth of each tire, etc. to the tire management server apparatus 60. The tire management server apparatus 60 collects the data for groove depth of the tire 7 in each vehicle received from the tire inspection apparatus 20.

The tire 7 is mounted on, for example, a plurality of vehicles such as cargo trucks operated under the management of, for example, a transport company. For the plurality of tires 7 mounted on each vehicle, the transport company can acquire tire groove depth data collected in the tire management server apparatus 60 and use it for maintenance of the tire.

It will be assumed that the groove depth measurement instrument 10 is, for example, a depth gauge and can transmit measured data through communication. The worker uses the groove depth measurement instrument 10 to measure, a plurality of times per groove, the groove depth of each groove provided in the tread part of the tire 7 mounted on the vehicle. The groove depth of the tire 7 is repeatedly inspected an interval of a predetermined period of time (e.g., several months) and collected in the tire management server apparatus 60. Further, the groove depth measurement instrument 10 may measure the depth of each groove of the tire 7 automatically by using a scanner, a stereo camera, etc.

Given that there are four grooves extending in the circumferential direction of the tire in the tread part of the tire, the groove depth of the tire 7 is measured at four locations in the width direction and further measured at three locations in the circumferential direction of the same groove at an interval of, for example, 120°. This makes it possible to acquire data for irregular wear in the width direction or the circumferential direction of the tire.

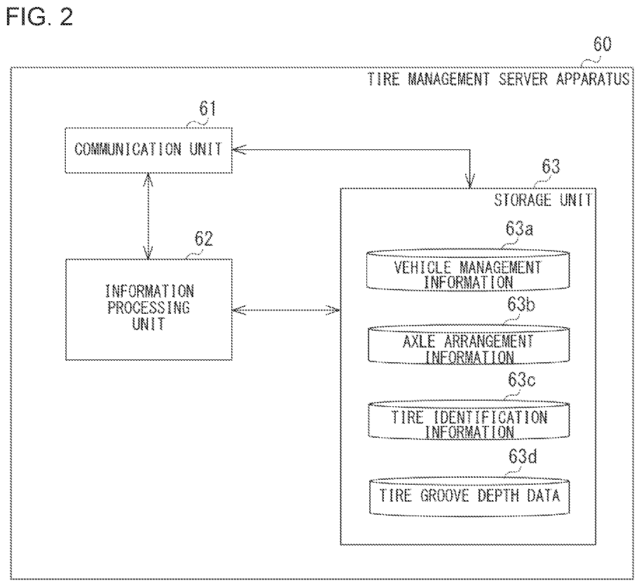

FIG. 2 is a block diagram showing a functional configuration of the tire management server apparatus 60. The tire management server apparatus 60 includes a communication unit 61, an information processing unit 62, and a storage unit 63. The parts in the tire management server apparatus 60 are implemented in hardware such as a processing circuit comprised of an electronic element exemplified by a CPU of a computer and a mechanical component, and in software such as a computer program. FIG. 2 depicts functional blocks implemented by the cooperation of these parts. Therefore, it will be understood by those skilled in the art that these functional blocks are implemented in a variety of manners by a combination of hardware and software.

The communication unit 61 is communicably connected to a communication network 8 by wireless or wired communication and communicates with the tire inspection apparatus 20.

The information processing unit 62 receives a request for transmission of information related to the vehicle and the tire 7 from the tire inspection apparatus 20 via the communication unit 61. The request for transmission of information related to the vehicle and the tire 7 from the tire inspection apparatus 20 includes, for example, identification information on the vehicle. The information processing unit 62 reads, from the storage unit 63, axle arrangement information 63b and tire identification information 63c for the vehicle, etc. identified by the request for transmission and transmits the information thus read to the tire inspection apparatus 20. The information processing unit 62 acquires the data for groove depth of the tire 7 from the tire inspection apparatus 20 via the communication unit 61 and stores and collects it in the storage unit 63 as tire groove depth data 63d.

The storage unit 63 is a storage device comprised of, for example, a solid state drive (SSD), a hard disk, a CD-ROM, a DVD, etc. The storage unit 63 stores vehicle management information 63a, axle arrangement information 63b, tire identification information 63c, and tire groove depth data 63d.

The vehicle management information 63a represent information related to a plurality of vehicles operated under the management of, for example, a transport company and includes the name of the vehicle, identification information on the vehicle assigned to each vehicle, etc. The axle arrangement information 63b represents information corresponding to each vehicle included in the vehicle management information 63a and related to the position of the axle and the tire 7 that is mounted.

The tire identification information 63c represents information such as a serial number assigned to each tire 7. For example, it is assumed that the tire identification information is readably stored in an RFID built in the tire 7. The tire identification information may be stored in the storage unit 63 in association with the vehicle that the tire 7 is mounted on and the position of the axle in the vehicle that the tire 7 is mounted on.

The tire groove depth data 63d represents data for groove depth of each tire 7 transmitted from the tire inspection apparatus 20 and is collected in the storage unit 63 along with the date and time of measurement, etc.

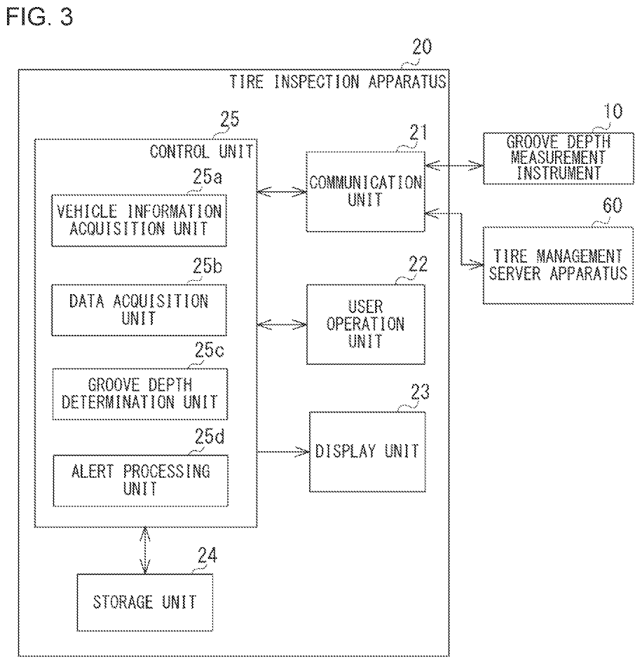

FIG. 3 is a block diagram showing a functional configuration of the tire inspection apparatus 20. The tire inspection apparatus 20 includes a communication unit 21, a user operation unit 22, a display unit 23, a storage unit 24, and a control unit 25 and is used to measure the groove depth of the tire 7. The tire inspection apparatus 20 acquires the data for groove depth of the tire 7 from the groove depth measurement instrument 10 and transmits the data to the tire management server apparatus 60.

The parts in the tire inspection apparatus 20 are implemented in hardware such as a processing circuit comprised of an electronic element exemplified by a CPU of a computer and a mechanical component, and in software such as a computer program. FIG. 3 depicts functional blocks implemented by the cooperation of these parts. Therefore, it will be understood by those skilled in the art that these functional blocks are implemented in a variety of manners by a combination of hardware and software.

The communication unit 21 is communicably connected to the communication network 8 by wireless or wired communication and communicates with the tire management server apparatus 60. Further, the communication unit 21 is communicably connected to the groove depth measurement instrument 10 by wireless or wired communication and acquires the data for groove depth of the tire 7.

The user operation unit 22 is an input apparatus that can be controlled by, for example, a touch panel, a switch, a keyboard, and a mouse. The worker manipulates the user operation unit 22 to acquire the information related to the vehicle in which the groove depth of the tire 7 is measured and to the tire from the tire management server apparatus 60.

The display unit 23 is a display apparatus such as a liquid crystal display. The display unit 23 displays information related to axle arrangement and the groove depth data for the tire 7 being measured.

The storage unit 24 is a storage apparatus comprised of a solid state drive, a hard disk, a CD-ROM, a DVD, etc. The storage unit 24 stores a computer program run by the control unit 25, axle arrangement information on the vehicle and identification information on the tire 7 acquired from the tire management server apparatus 60, the data for groove depth of the tire 7, etc.

The control unit 25 includes a vehicle information acquisition unit 25a, a data acquisition unit 25b, a groove depth determination unit 25c, and a alert processing unit 25d. The vehicle information acquisition unit 25a requests the tire management server apparatus 60 to transmit information on the vehicle and the tire selected in the user operation of the worker in the user operation unit 22 and acquires the axle arrangement and the identification information on the tire transmitted from the tire management server apparatus 60.

The data acquisition unit 25b acquires, for each tire 7 mounted on a given vehicle, successively measured data for groove depth from the groove depth measurement instrument 10. The data acquisition unit 25b acquires the data for groove depth measured by the groove depth measurement instrument a plurality of times per groove. For a plurality of grooves extending in the circumferential direction of the tire in the tread part of a given tire 7, the data acquisition unit 25b acquires the data for groove depth measured at three locations in the circumferential direction of the same groove at an interval of, for example, 120°.

The data acquisition unit 25b successively acquires the data for groove depth of further grooves provided alongside in the tire width direction similarly measured at three locations. After the data acquisition unit 25b acquires the data for groove depth for all grooves of the given tire 7, the data acquisition unit 25b continues to acquire the data for groove depth of the respective tires in the vehicle in a similar sequence of steps.

The groove depth determination unit 25c determines whether a per-groove difference in groove depth acquired by the data acquisition unit 25b is equal to or larger than a predetermined value. The groove depth determination unit 25c refers to a plurality of items of data for groove depth measured in a given groove of a given tire 7, calculates a difference between the items of data (maximum value), and determines whether the value of the difference is equal to or larger than a predetermined value. The predetermined value is set to a value in a range between 1 mm and 3 mm, both inclusive, but the range is not limited to this and may be defined in accordance with the size of the tire, the groove formed in the tire, etc.

When the groove depth determination unit 25c determines that the difference between the items of data (maximum value) is equal to or larger than the predetermined value, the groove depth determination unit 25c determines that the measurement of groove depth is in error and that the same groove should be measured again. The groove depth determination unit 25c outputs a determination result indicating that the measurement should be made again to the alert processing unit 25d. The data acquisition unit 25b acquires the data for tire groove depth of the same groove. When the groove depth determination unit 25c determines that difference between the items of data (maximum value) is smaller than the predetermined value, the groove depth determination unit 25c determines that the measurement of groove depth is conducted properly, and the data acquisition unit 25b acquires the data for groove depth of the next groove.

The alert processing unit 25d generates a notification for alerting outside that the groove depth should be measured again. When a determination result indicating that the measurement should be made again is input from the groove depth determination unit 25c, the alert processing unit 25d generates an alert by displaying an image prompting re-measurement on the display unit 23. Based on the image prompting re-measurement on the display unit 23, the worker will measure the groove depth of the same groove by using the groove depth measurement instrument 10.

When a determination result indicating that the measurement should be made again is input from the groove depth determination unit 25c, the alert processing unit 25d may generate an alert by outputting a sound such as an alarm sound and a message from a speaker (not shown) to prompt for re-measurement. The alert processing unit 25d may generate an alert by vibrating the groove depth measurement instrument 10 to prompt for re-measurement. Based on the sound or vibration prompting for re-measurement, the worker will measure the groove depth of the same groove again by using the groove depth measurement instrument 10. The alert processing unit 25d may output an alert outside both by displaying an image and outputting a sound to indicate that the groove depth should be measured again.

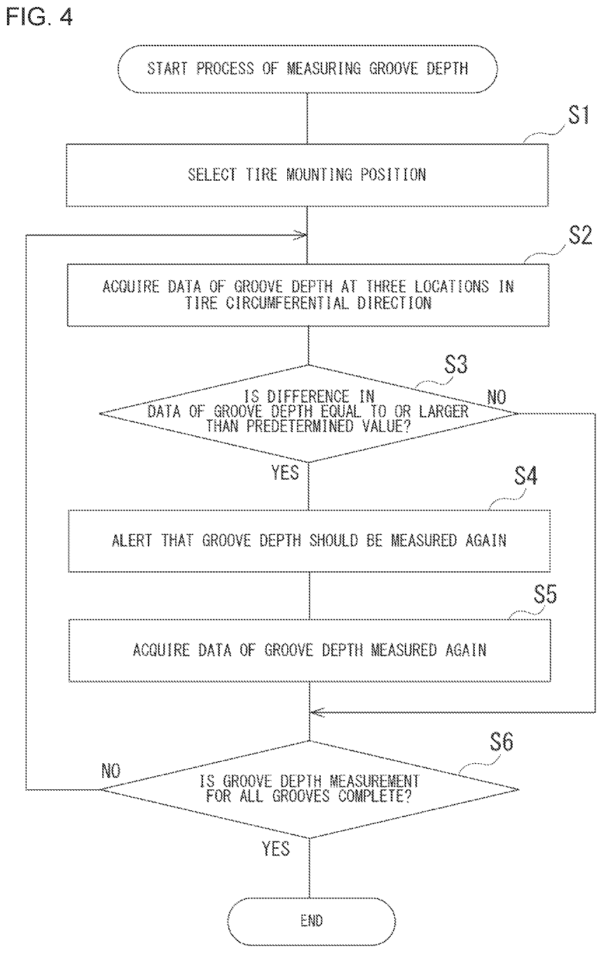

A description will now be given of the operation of the tire inspection system 100. FIG. 4 is a flowchart showing a sequence of steps of a process performed by the tire inspection system 100 to measure the groove depth. It is assumed that the vehicle information acquisition unit 25a of the tire inspection apparatus 20 acquires, from the tire management server apparatus 60, the axle arrangement, the tire identification information, etc. for the vehicle for which the groove depth of the tire 7 is measured. The data acquisition unit 25b of the tire inspection apparatus 20 selects the tire mounting position of the target of measurement based on the user operation of the worker in the user operation unit 22 (S1).

The data acquisition unit 25b selects one groove in the tire 7 selected in step S1 and acquires the data for groove depth measured at three locations per groove in the circumferential direction of the tire (S2). The data for groove depth is measured by the worker by using the groove depth measurement instrument 10 and transmitted from the groove depth measurement instrument 10 to the tire inspection apparatus 20.

The groove depth determination unit 25c determines whether a per-groove difference in the data for groove depth (maximum value) is equal to or larger than a predetermined value (S3). When the difference in the data for groove depth (maximum value) is equal to or larger than the predetermined value (S3: YES), the alert processing unit 25d alerts the worker that the groove depth should be measured again (S4). The data acquisition unit 25b acquires the data for groove depth measured again (S5).

The data acquisition unit 25b determines whether the measurement of groove depth is completed for all grooves of the tire 7 (S6). When the data acquisition unit 25b determines that the measurement is completed for all grooves (S6: YES), the process is terminated. When it is determined in step S6 that the measurement is not completed for all grooves (S6: NO), the data acquisition unit 25b selects the next groove and returns to step S2 to repeat the process. Further, when it is determined in step S3 that the difference in the data for groove depth (maximum value) is smaller than the predetermined value (S3: NO), the process proceeds to step S6.

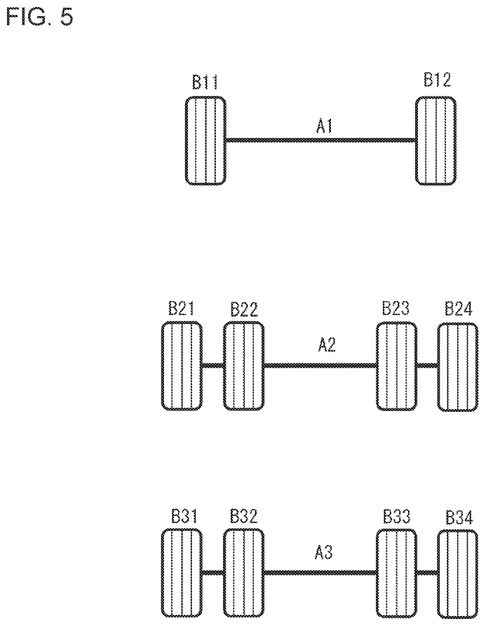

FIG. 5 is a schematic diagram showing an example of axle arrangement information 63b. The axle arrangement information 63b shown in FIG. 5 shows three axles A1, A2, and A3 in the longitudinal direction of a vehicle and tire mounting positions B11, B12, etc. in the respective axles. A total of 10 tires are arranged in the axles. The data acquisition unit 25b selects the tire mounting position subject to measurement based on the user operation of the worker in the user operation unit 22 and acquires the data for groove depth based on the flowchart shown in FIG. 4. When the data acquisition unit 25b completes acquisition of all data for groove depth of a given tire, the data acquisition unit 25b selects the next tire mounting position and acquires the data for groove depth. By repeating these steps, the data acquisition unit 25b acquires the data for groove depth of all tires mounted on the vehicle.

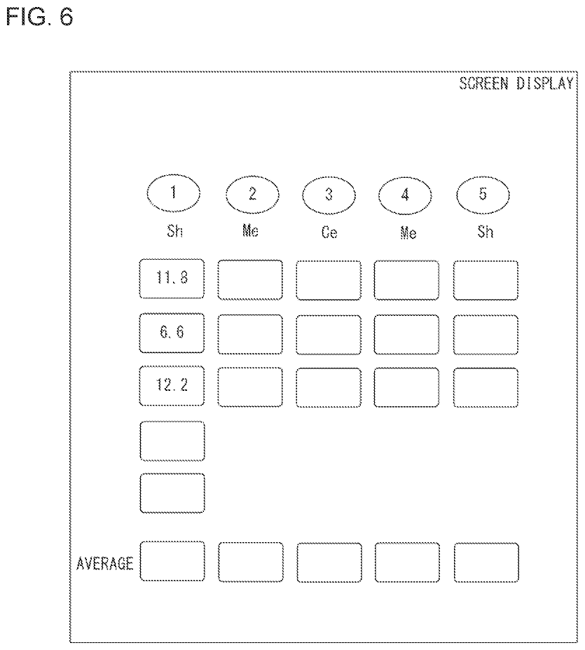

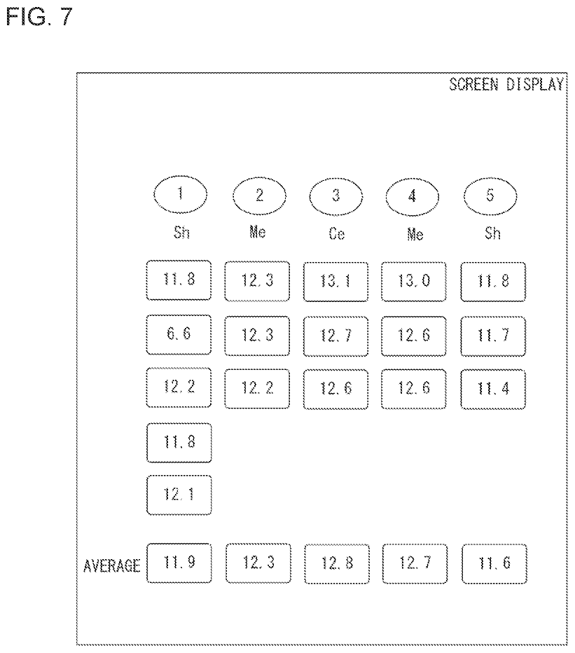

FIG. 6 is a schematic diagram showing an exemplary image displayed on the display unit 23 while a groove depth is being measured. FIG. 7 is a schematic diagram showing an exemplary image displayed on the display unit 23 after a groove depth is measured. In the example shown in FIG. 6, groove 1 through groove 5 are located in a given tire 7. The position of each groove in the tire width direction is represented by Sh (shoulder), Me (medium), and Ce (center).

The data (unit: mm) for the result of measuring the groove depth of groove 1 at three locations in the circumferential direction of the tire is shown in the rectangular frame. The difference in the data for groove depth of groove 1 is equal to or larger than a predetermined value (e.g., 1 mm). Therefore, the alert processing unit 25d alerts the worker that re-measurement should be made twice by displaying two blank rectangular frames on the display unit 23. In this process, the alert processing unit 25d may prompt the worker for re-measurement by outputting a sound such as an alarm sound and a message.

The example shown in FIG. 7 shows the result of measurement of groove depth of groove 1 through groove 5, including re-measurement of groove 1, and average values of groove depth in the respective grooves calculated.

If, for example, the data for groove depth in error is re-measured after the groove depth of all tires of a vehicle is measured, the worker has to take a great trouble of, for example, moving to the mounting position of the tire 7 in the vehicle and preparing the groove depth measurement instrument 10 and the tire inspection apparatus 20 for a second time.

The tire inspection system 100 determines, using the groove depth determination unit 25c, whether the difference in groove depth acquired is equal to or larger than the predetermined value. When it is determined that the difference is equal to or larger than the predetermined value, the tire inspection system 100 outputs, using the alert processing unit 25d, an alert outside to indicate that the groove depth should be measured again. This makes it possible for the tire inspection system 100 to correct an error in groove depth measurement for each groove of the tire 7 and conduct an inspection of the groove depth of the tire efficiently.

In the above example, the alert processing unit 25d outputs an alert outside to indicate that the groove depth should be measured again after each groove is measured. The tire inspection system 100 may, after the groove depth of all grooves in a given tire are measured, examine, using the groove depth determination unit 25c, the measurement data for each groove and output, using the alert processing unit 25d, an alert outside to indicate a groove for which re-measurement is necessary. Further, the data acquisition unit 25b can increase the reliability of data by acquiring at least two items of data for groove depth in the re-measurement of groove depth.

The alert processing unit 25d of the tire inspection apparatus 20 can let the worker know that re-measurement is necessary in a manner easy to understand visually by displaying an image to alert the worker. Further, the alert processing unit 25d may alert the worker by outputting a sound such as an alarm sound and a message, which makes it possible to let the worker know that re-measurement is necessary in a manner easy to understand audibly.

A description will now be given of the feature of the tire inspection system 100 and the tire inspection program according to the embodiment. The tire inspection system 100 includes the data acquisition unit 25b, the groove depth determination unit 25c, and the alert processing unit 25d. The data acquisition unit 25b acquires the data for groove depth derived from measuring the groove depth of the tire 7 mounted on the vehicle a plurality of times per groove by using the groove depth measurement instrument 10. The groove depth determination unit 25c determines whether a per-groove difference in groove depth acquired by the data acquisition unit 25b is equal to or larger than a predetermined value. When the groove depth determination unit 25c determines that the difference is equal to or larger than the predetermined value, the alert processing unit 25d outputs an alert to indicate that the groove depth should be measured again. This makes it possible for the tire inspection system 100 to conduct an inspection of the groove depth of the tire efficiently.

Further, the alert processing unit 25d outputs an alert by displaying an image. This allows the tire inspection system 100 to let the worker know that re-measurement is necessary in a manner easy to understand visually.

Further, the alert processing unit 25d outputs an alert by outputting a sound. This allows the tire inspection system 100 to let the worker know that re-measurement is necessary in a manner easy to understand audibly.

Further, the data for groove depth is derived from measurement at different positions in the circumferential direction of the tire 7. This allows the tire inspection system 100 to correct an error in groove depth measurement for each groove of the tire 7.

Further, the data acquisition unit 25b acquires at least two items of data for groove depth in the re-measurement of groove depth. This allows the tire inspection system 100 to increase the reliability of measurement data for groove depth.

A tire inspection program on a non-volatile recording medium for tire inspection encoded with the program causes a computer to execute a data acquisition step, a groove depth determination step, and an alert processing step. The data acquisition step acquires data for groove depth derived from measuring the groove depth of the tire 7 mounted on the vehicle a plurality of times per groove. The groove depth determination step determines whether a per-groove difference in groove depth acquired by the data acquisition step is equal to or larger than a predetermined value. When the groove depth determination step determines that the difference is equal to or larger than the predetermined value, the alert processing step outputs an alert to indicate that the groove depth should be measured again. According to this tire inspection program, it is possible to conduct an inspection of the groove depth of the tire efficiently.

The present invention has been described above based on an embodiment. The embodiment is intended to be illustrative only and it will be understood by those skilled in the art that various modifications and changes are possible within the claim scope and that such modifications and changes are also within the claim scope of the present invention. Therefore, the description in this specification and the drawings shall be treated to serve illustrative purposes and shall not limit the scope of the invention.

What is claimed is:

1. A tire inspection apparatus comprising:
a data acquisition unit that acquires, from a groove depth measurement instrument, at least two groove depth data of a given groove in a tire mounted on a vehicle;
a groove depth determination unit that determines whether a difference in the groove depth data of the given groove acquired by the data acquisition unit is equal to or larger than a predetermined value; and
an alert processing unit that generates, when the groove depth determination unit determines that the difference is equal to or larger than the predetermined value, a notification for re-measurement of a groove depth.

2. The tire inspection apparatus according to claim 1, further comprising a display unit that displays information related to the tire, wherein
the notification generated by the alert processing unit includes displaying an image on the display unit.

3. The tire inspection apparatus according to claim 1, further comprising a speaker that outputs alert to worker, wherein
the notification generated by the alert processing unit includes outputting a sound by the speaker.

4. The tire inspection apparatus according to claim 1, wherein
the vehicle is a vehicle operated under management of a transport company.

5. The tire inspection apparatus according to claim 1, wherein
a groove of the tire extends in a circumferential direction of the tire, and
the groove depth data is derived from measuring the given groove at different positions in the circumferential direction of the tire.

6. The tire inspection apparatus according to claim 1, wherein
the groove depth determination unit makes a determination on measurement data for each groove after the data acquisition unit acquires a groove depth for all grooves of the tire, and
the alert processing unit alerts of a groove for which re-measurement is necessary, based on a determination result of the groove depth determination unit.

7. The tire inspection apparatus according to claim 1, further comprising:
a vehicle information acquisition unit that acquires axle arrangement information on the vehicle from an external apparatus, wherein
the axle arrangement information includes information related to a position of an axle and the tire of the vehicle.

8. The tire inspection apparatus according to claim 7, wherein
when acquisition of data for groove depth of a given tire of the vehicle is completed, a next tire mounting position is selected and data for groove depth of the tire is acquired based on the axle arrangement information.

9. The tire inspection apparatus according to claim 1, wherein
the data acquisition unit acquires, in re-measurement of groove depth, the groove depth data at different positions in the given groove in a circumferential direction of the tire.

10. A tire inspection system comprising:
a tire management server apparatus comprising:
a storage unit that stores axle arrangement information including information related to a position of an axle and a tire of the vehicle; and
an information processing unit that reads the axle arrangement information from the storage unit and transmits the axle arrangement information; and
a tire inspection apparatus comprising:
a vehicle information acquisition unit that acquires the axle arrangement information on the vehicle from the tire management server apparatus;
a data acquisition unit that acquires, from a groove depth measurement instrument, at least two groove depth data of a given groove in a tire mounted on a vehicle based on the axle arrangement information;
a groove depth determination unit that determines whether a difference in the groove depth data of the given groove acquired by the data acquisition unit is equal to or larger than a predetermined value; and
an alert processing unit that generates, when the groove depth determination unit determines that the difference is equal to or larger than the predetermined value, a notification for re-measurement of a groove depth of a relevant groove.

11. The tire inspection system according to claim 10, further comprising a display unit that displays information related to the tire, wherein
the notification generated by the alert processing unit includes displaying an image on the display unit.

12. The tire inspection system according to claim 10, further comprising a speaker that outputs alert to worker, wherein
the notification generated by the alert processing unit includes outputting a sound by the speaker.

13. The tire inspection system according to claim 10, wherein
the vehicle is a vehicle operated under management of a transport company.

14. The tire inspection system according to claim 10, wherein
a groove of the tire extends in a circumferential direction of the tire, and
the groove depth data measured a plurality of times is derived from measuring the given groove at different positions in the circumferential direction of the tire.

15. The tire inspection system according to claim 10, wherein
after the data acquisition unit acquires a groove depth for all grooves of a given tire, the groove depth determination unit makes a determination on measurement data for respective grooves, and
the alert processing unit alerts of a groove for which re-measurement is necessary, based on a determination result of the groove depth determination unit.

16. The tire inspection system according to claim 10, wherein
when acquisition of data for groove depth of a given tire of the vehicle is completed, a next tire mounting position is selected and data for groove depth of the tire is acquired based on the axle arrangement information.

17. The tire inspection system according to claim 10, wherein
the data acquisition unit acquires, in re-measurement of groove depth, the groove depth data at different positions in the given groove in a circumferential direction of the tire.

18. A non-volatile recording medium for tire inspection encoded with a program, the program comprising computer-implemented modules including:
a data acquisition module that acquires at least two groove depth data of a given groove of a tire mounted on a vehicle;
a groove depth determination module that determines whether a difference in the groove depth data of the given groove acquired by the data acquisition module is equal to or larger than a predetermined value; and
an alert processing module that generates, when the groove depth determination module determines that the difference is equal to or larger than the predetermined value, a notification for re-measurement of a groove depth.
